(19) United States
(12) Patent Application Publication
(10) Pub. No.: US 2012/0162190 A1
(43) Pub. Date: Jun. 28, 2012

(54) APPARATUS AND METHOD FOR DRIVING MULTI-STABLE DISPLAY PANEL

(75) Inventors: Po-Chun Yeh, Tainan City (TW); Heng-Yin Chen, Hsinchu County (TW); Cheng-Wei Sun, Taoyuan County (TW); Wei-Yen Lee, Taichung City (TW)

(73) Assignee: INDUSTRIAL TECHNOLOGY RESEARCH INSTITUTE, Hsinchu (TW)

(21) Appl. No.: 13/041,356

(22) Filed: Mar. 5, 2011

(30) Foreign Application Priority Data
Dec. 22, 2010 (TW) 99145256

(51) Int. Cl. G06F 3/038

(52) U.S. Cl. 345/214

(57) ABSTRACT

An apparatus and a method for driving multi-stable display panel are provided. The method includes selecting a plurality of target scan lines from a plurality of scan lines of the multi-stable display panel; driving the target scan lines during a line-scanning period; and providing a first voltage level to other scan lines besides the target scan lines during the line-scanning period. Wherein, the line-scanning period includes a plurality of time slots. The target scan lines are respectively provided with a third voltage level during at least a corresponding time slot of the time slots, and are provided with the first voltage level during other time slots besides the corresponding time slot. A data line of the multi-stable display panel is correspondingly provided with a second voltage level or a fourth voltage level in the time slots.

### CROSS-REFERENCE TO RELATED APPLICATION

This application claims the priority benefit of Taiwan application serial no. 99145256, filed Dec. 22, 2010. The entirety of the above-mentioned patent application is hereby incorporated by reference herein and made a part of this specification.

### BACKGROUND

1. Technical Field

The disclosure relates to a display. Particularly, the disclosure relates to an apparatus and a method for driving a multi-stable display panel.

2. Related Art

FIG. 1 is a functional block diagram of a conventional passive matrix (PM) multi-stable display 100. The PM multi-stable display 100 includes a data driver 110, a scan driver 120 and a display panel 130. The display panel 130 has a plurality of scan lines S(1), S(2), S(3), S(4), S(5), S(6), . . . , S(N) and a plurality of data lines D(1), D(2), D(3), D(4), . . . , D(M-1), D(M). A multi-stable display medium 131 is disposed between the scan lines and the data lines, for example, cholesteric liquid crystal (ChLC). Therefore, a plurality of multi-stable pixels is formed between the scan lines and the data lines, for example, a pixel PX shown in FIG. 1.

FIG. 2 is a timing schematic diagram of scan signals and data signals of the conventional PM multi-stable display. Referring to FIG. 1 and FIG. 2, the scan driver 120 sequentially drives the scan lines S(1)-S(N) in a sequence from S(1) to S(N) during a frame driving period F. The conventional driving technique is to drive a single scan line (addressing line) during a same line-scanning period L. In collaboration with the driving timing of the scan lines S(1)-S(N), the data driver 110 correspondingly writes a plurality of data signals into the pixels through the data lines D(1)-D(M). For example, when the scan driver 120 drives the scan line S(1) during the line-scanning period L, the data driver 110 correspondingly writes pixel data into the multi-stable pixel PX through the data line D(M) during the same line-scanning period L.

As described above, the conventional driving method of the ChLC is to write corresponding driving waveforms to the scan lines S(1)-S(N) row-by-row. Therefore, the time F for the conventional driving method refreshing the whole panel frame is N x L, as that shown in FIG. 2. The larger a panel size is, the greater the amount N of the scan lines is, and the longer the time F for refreshing the whole panel frame is.

### SUMMARY

The disclosure is directed to an apparatus and a method for driving a multi-stable display panel.

An exemplary embodiment of the disclosure provides a method for driving a multi-stable display panel. The method includes selecting a plurality of target scan lines from a plurality of scan lines of the multi-stable display panel; providing a first voltage level to the other scan lines besides the target scan lines during the line-scanning period; and driving the target scan lines during a line-scanning period, where the line-scanning period includes a plurality of time slots. The target scan lines are respectively provided with a third voltage level during at least a corresponding time slot of the time slots, and are provided with the first voltage level during other time slots besides the corresponding time slot. A data line of the multi-stable display panel is correspondingly provided with a second voltage level or a fourth voltage level in the time slots.

An exemplary embodiment of the disclosure provides an apparatus for driving a multi-stable display panel. The apparatus includes a scan driver and a data driver. The scan driver is used for connecting a plurality of scan lines of the multi-stable display panel. The scan driver selects a plurality of target scan lines from the scan lines, and drives the target scan lines during a line-scanning period, and provides a first voltage level to the other scan lines besides the target scan lines during the line-scanning period, where the line-scanning period includes a plurality of time slots. The scan driver provides a third voltage level to each of the target scan lines during at least a corresponding time slot of the time slots, and provides the first voltage level during other time slots besides the corresponding time slot. The data driver is used for connecting at least one data line of the multi-stable display panel, and correspondingly provides a second voltage level or a fourth voltage level to the data line in the time slots.

An exemplary embodiment of the disclosure provides a method for driving a multi-stable display panel. The method includes providing a first voltage level to a scan line of a pixel during a time slot of a line-scanning period when a state of the pixel is not changed; respectively providing a second voltage level and a third voltage level to a data line and the scan line of the pixel during the time slot when the state of the pixel is to be set to a bright state, where the third voltage level is greater than the first voltage level, the second voltage level is between the first voltage level and the third voltage level; and respectively providing the third voltage level and a fourth voltage level to the scan line and the data line of the pixel during the time slot when the state of the pixel is to be set to a dark state, where the fourth voltage level is smaller than or equal to the first voltage level.

An exemplary embodiment of the disclosure provides an apparatus for driving a multi-stable display panel. The apparatus includes a scan driver and a data driver. The scan driver is used for connecting at least one scan line of the multi-stable display panel. When a state of a pixel is not changed, the scan driver provides a first voltage level to the scan line of the pixel during a time slot of a line-scanning period. When the state of the pixel is to be set to a bright state or a dark state, the scan driver provides a third voltage level to the scan line of the pixel during the time slot, where the third voltage level is greater than the first voltage level. The data driver is used for connecting at least one data line of the multi-stable display panel. When the state of the pixel is to be set to the bright state, the data driver provides a second voltage level to the data line of the pixel during the time slot. When the state of the pixel is to be set to the dark state, the data driver provides a fourth voltage level to the data line of the pixel during the time slot, where the second voltage level is between the first voltage level and the third voltage level, and the fourth voltage level is smaller than or equal to the first voltage level.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a functional block diagram of a conventional passive matrix (PM) multi-stable display 100.

FIG. 2 is a timing schematic diagram of scan signals and data signals of a conventional PM multi-stable display.

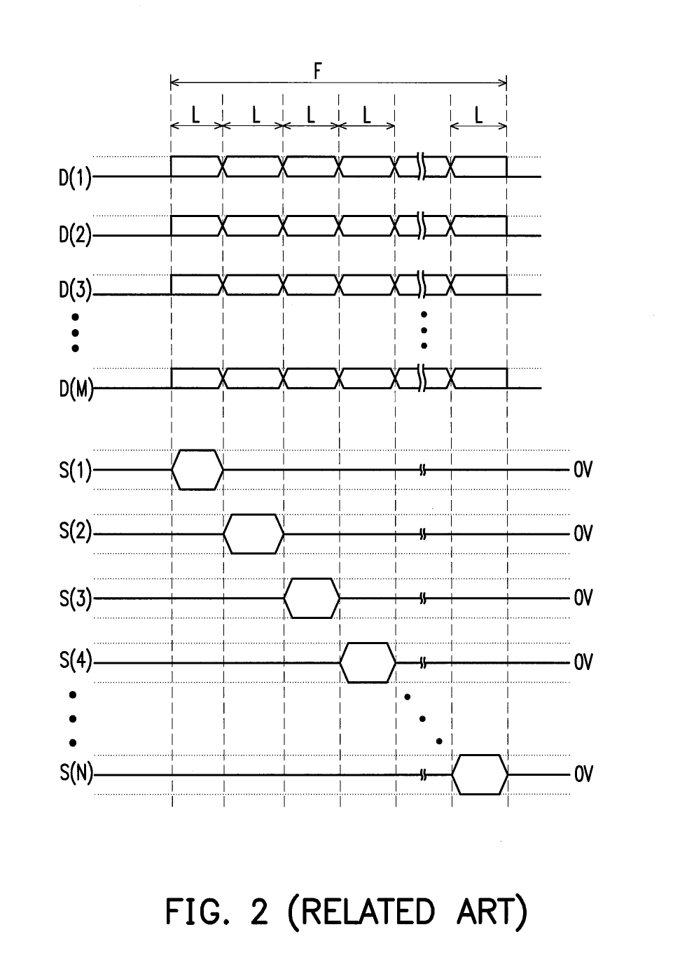

FIG. 3 is an ideal curve diagram of a reflectivity-voltage characteristic curve of cholesteric liquid crystal (ChLC).

FIG. 4 is a driving timing diagram of scan lines S(1)-S(N) and data lines D(1)-D(M) of a pixel matrix according to an exemplary embodiment of the disclosure.

FIG. 5 is a diagram illustrating a driving method of a multi-stable display panel according to an exemplary embodiment of the disclosure.

FIG. 6 is a diagram illustrating a driving method of a multi-stable display panel according to another exemplary embodiment of the disclosure.

FIG. 7 is a functional block schematic diagram of a passive matrix (PM) multi-stable display according to another exemplary embodiment of the disclosure.

### DETAILED DESCRIPTION OF DISCLOSED EMBODIMENTS

In an exemplary embodiment of the disclosure, driving waveforms can be provided to a plurality of scan lines during the same line-scanning period, i.e. the scan lines are driven during the same line-scanning period, so as to shorten a time for writing pixel data. For example, if a number of the scan lines is N, the line-scanning period is L, and n scan lines are simultaneously driven during the same line-scanning period L (n≧2), a driving apparatus and a driving method disclosed by the exemplary embodiment of the disclosure can shorten a frame refresh time to N×L÷n. Therefore, a frame refresh speed can be accelerated according to the disclosure.

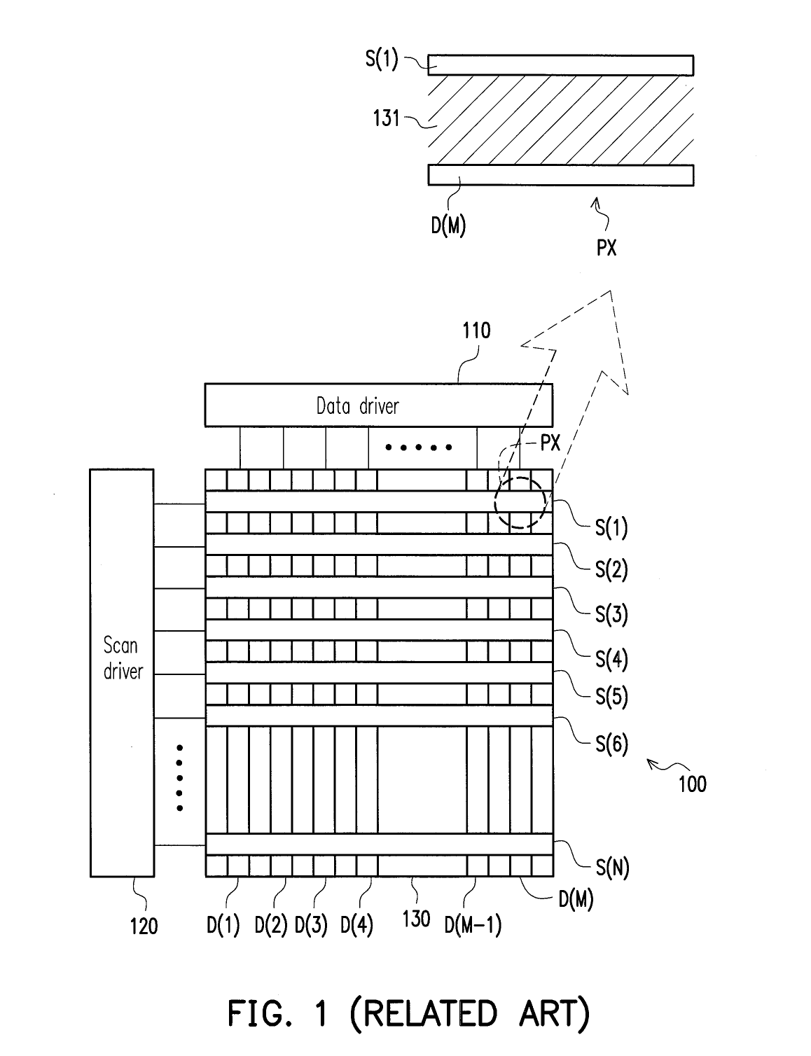

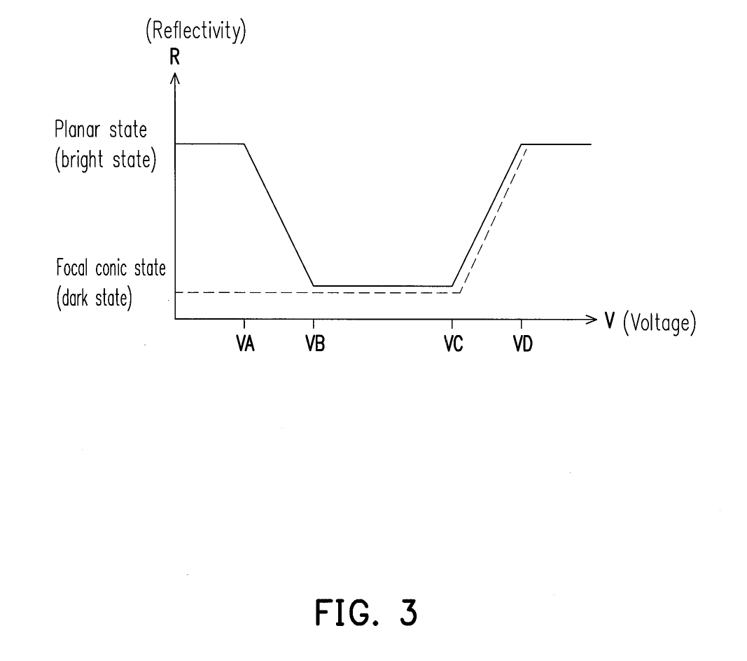

In the following exemplary embodiment, a multi-stable display medium (cholesteric liquid crystal (ChLC) or other multi-stable display media) is used to describe exemplary embodiments of the apparatus and the method for driving the multi-stable display panel of the disclosure. FIG. 3 is an ideal curve diagram of a reflectivity-voltage characteristic curve of the ChLC. A horizontal axis of FIG. 3 represents a voltage amplitude (an absolute value) between two electrodes in a multi-stable pixel (for example, the scan line S(1) and the data line D(M) of a pixel PX of FIG. 1), and a vertical axis represents a light reflectivity of the multi-stable pixel. A solid line in FIG. 3 represents a characteristic curve when an initial state of the liquid crystal molecules is a planar state (or a bright state), and a dot line represents a characteristic curve when the initial state of the liquid crystal molecules is a focal conic state (or a dark state).

If the initial state of the pixel is the bright state (referring to the solid line in FIG. 3), as the voltage amplitude of the electrodes is increased from VA to VB, the state of the pixel is changed from the bright state to the dark state. If the voltage amplitude of the electrodes is continually increased, as the voltage amplitude is increased from VC to VD, the state of the pixel is changed from the homotropic state to the bright state.

If the initial state of the pixel is the dark state (referring to the dot line in FIG. 3), during a pulling-up process of the voltage amplitude between the electrodes, the state of the pixel is maintained to the dark state. If the voltage amplitude between the electrodes is continually increased, as the voltage amplitude is increased from VC to VD, the dark state pixel is changed from the homotropic state to the bright state.

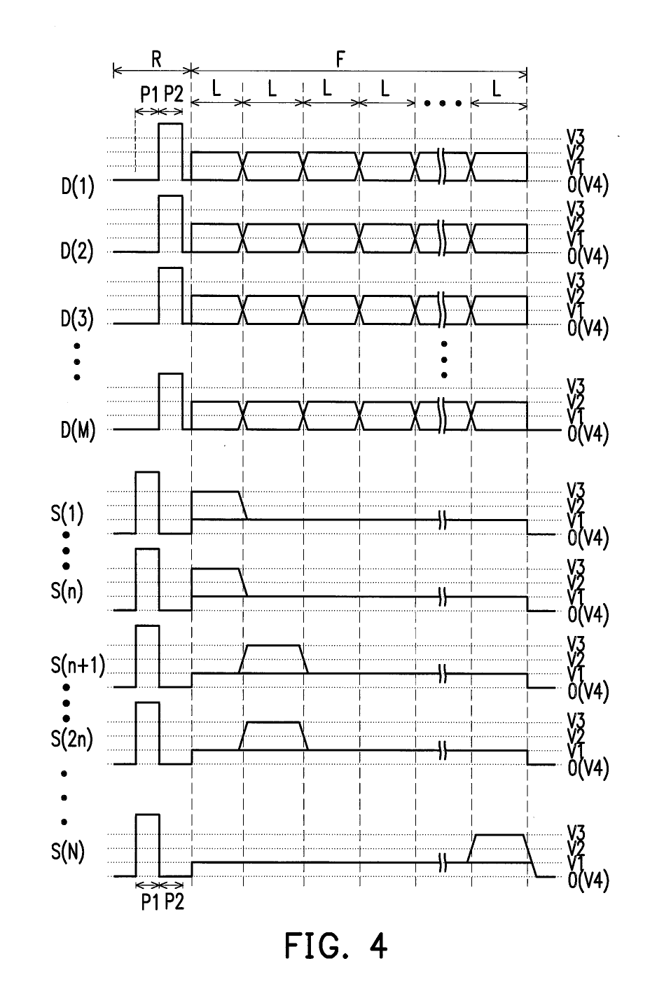

In the following embodiments, the multi-stable display 100 of FIG. 1 is taken as an example for descriptions, and a left part of the reflectivity-voltage characteristic curve of FIG. 3 (with a range smaller than VC) is used to drive the pixel (for example, the pixel PX). FIG. 4 is a driving timing diagram of scan lines S(1)-S(N) and data lines D(1)-D(M) of a pixel matrix according to an exemplary embodiment of the disclosure. The fourth voltage level V4 is smaller than or equal to the first voltage level V1.

Referring to FIG. 4, before a frame driving period F is started, a reset period R can be arranged. During the reset period R, states of all of the multi-stable pixels in the multi-stable display panel 130 are simultaneously reset to the bright state. Here, the multi-state pixel PX, the scan line S(1) and the data line D(M) of FIG. 1 are taken as an example for description, and descriptions of the other multi-state pixels, scan lines and date lines can be deduced by analogy. If the state of the multi-stable pixel PX is to be reset, the scan driver 120 and the data driver 110 respectively provide the first reset voltage and the second reset voltage to the scan line S(1) and the data line D(M) at the first stage P1, and then respectively provide the second reset voltage and the first reset voltage to the scan line S(1) and the data line D(M) at the second stage P2. Levels of the above the first reset voltage and the second reset voltage are determined according to a characteristic of the multi-stable display medium 131. hi the present exemplary embodiment, the first reset voltage is greater than the third voltage level (for example, the first reset voltage is greater than the voltage VD shown in FIG. 3), the second reset voltage is approximately equal to the fourth voltage level (for example, a ground voltage, 0V or other fixed reference voltages) or is smaller than the fourth voltage level. Therefore, the states of all of the multi-stable pixels in the pixel matrix are reset to the bright state.

The frame driving period F includes a plurality of the line-scanning periods L. The scan driver 120 is connected to a plurality of the scan lines S(1)-S(N) of the multi-stable display panel 130. The scan driver 120 selects n target scan lines from the scan lines S(1)-S(N) (n≧2). The scan driver 120 drives the selected target scan lines during the same line-scanning period L, and the unselected other scan lines are not provided with driving waveforms. For example, the scan driver 120 provides the first voltage level V1 to the other scan lines besides the target scan lines.

For example, the scan driver 120 selects the scan lines S(1)-S(n) as the target scan lines during the first line-scanning period L of the frame driving period F. Then, the scan driver 120 provides driving waveforms to the target scan lines S(1)-S(n) during the same line-scanning period L, and does not provide the driving waveforms to the other scan lines S(n+1)-S(N). Then, deduced by analogy, the scan driver 120 provides the driving waveforms to another set of target scan lines S(n+1)-S(2n) during the next line-scanning period L, and does not provide the driving waveforms to the other scan lines (for example, S(1)-S(n), S(2n+1)-S(N), etc.).

The data driver 110 is connected to the data lines D(1)-D(M) of the multi-stable display panel 130. Based on the scan timing of the scan lines S(1)-S(N) shown in FIG. 4, the data driver 110 writes a plurality of pixel data to the corresponding multi-stable pixels through the data lines D(1)-D(M).

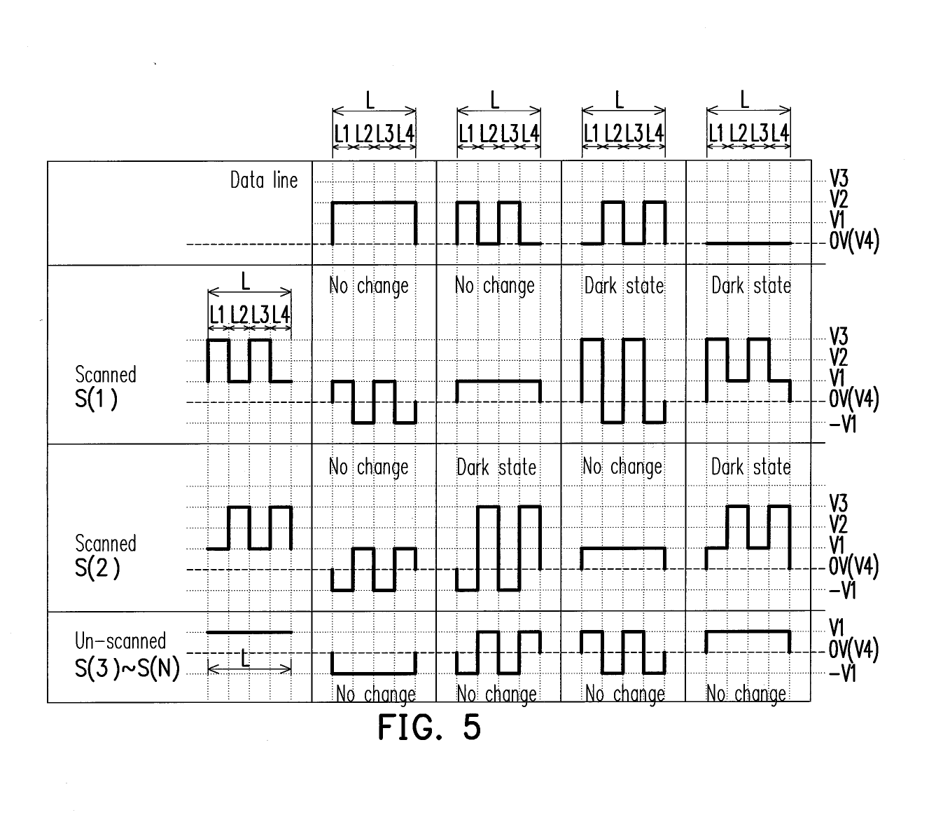

The driving waveforms of the target scan lines are described below, though implementation of the disclosure is not limited thereto. FIG. 5 is a diagram illustrating a driving method of the multi-stable display panel according to an exemplary embodiment of the disclosure. Here, it is assumed that the scan driver 120 of FIG. 1 simultaneously drives two scan lines (i.e. n=2, referring to FIG. 4) during the same line-scanning period L, so that the scan driver 120 selects the scan lines S(1) and S(2) as the target scan lines during the first line-scanning period L of the frame driving period F. In FIG. 5, the driving waveforms during the first line-scanning period L of the frame driving period F of FIG. 4 are illustrated. The driving waveforms during the other line-scanning periods L can be deduced by analogy according to the embodiment of FIG. 5.

The scan driver 120 selects the scan lines S(1) and S(2) as the target scan lines (the scanned scan lines) during the line-scanning period L, and provides the first voltage level V1 to the other scan lines (the un-scanned scan lines, for example, S(3)-S(N)) besides the target scan lines S(1) and S(2) during the line-scanning period L. The line-scanning period L includes a plurality of time slots. The number of the time slots included in the line-scanning period L can be determined according to an actual design requirement. In the present exemplary embodiment, the line-scanning period L includes time slots L1, L2, L3 and L4, as that shown in FIG. 5.

The scan driver 120 provides the third voltage level V3 to each of the target scan lines S(1) and S(2) during at least a corresponding time slot of the time slots L1-L4, and provides the first voltage level V1 during the other time slots slot of the time slots L1-L4 besides the corresponding time slot. For example, the corresponding time slots of the scan line S(1) are L1 and L3, and the corresponding time slots of the scan line S(2) are L2 and L4. Therefore, the scan driver 120 provides the third voltage level V3 to the target scan line S(1) during the time slots L1 and L3, and provides the first voltage level V1 to the target scan line S(1) during the time slots L2 and L4. Similarly, the scan driver 120 provides the third voltage level V3 to the target scan line S(2) during the time slots L2 and L4, and provides the first voltage level V1 to the target scan line S(2) during the time slots L1 and L3.

Anyway, the driving waveforms of the scan lines are not limited to that shown in FIG. 5. In other embodiments, the scan driver 120 respectively provides the first voltage level V1 and the third voltage level V3 to the target scan lines S(1) and S(2) during the time slots L1 and L3, and respectively provides the third voltage level V3 and the first voltage level V1 to the target scan lines S(1) and S(2) during the time slots L2 and L4. Alternatively, the scan driver 120 respectively provides the first voltage level V1 and the third voltage level V3 to the target scan lines S(1) and S(2) during the time slots L1 and L2, and respectively provides the third voltage level V3 and the first voltage level V1 to the target scan lines S(1) and S(2) during the time slots L3 and L4.

Referring to FIG. 5, corresponding to the driving waveforms exerted to the target scan lines S(1) and S(2) by the scan driver 120 during the line-scanning period L, the data driver 110 respectively provides the second voltage level V2 or the fourth voltage level V4 to the data lines D(1)-D(M) during the time slots L1-L4. For example, if the states of the pixels on the scan lines S(1) and S(2) are to be set to the bright state (the planar state), since the pixels are all reset to the bright state, the data driver 110 provides the second voltage level V2 to the data lines of the pixels during the time slots L1-L4, where the third voltage level V3 is greater than the first voltage level V1, and the second voltage level V2 is between the first voltage level V1 and the third voltage level V3. For example, the second voltage level V2 is twice of the first voltage level V1, and the third voltage level is triple of the first voltage level V1. Since the voltage amplitudes between two ends of the pixels do not exceed a reflectivity transition voltage (which is equivalent to the voltage VA shown in FIG. 3), the states of the pixels are not changed and are maintained to the bright state.

If the states of the pixels on the scan line S(1) are to be set to the bright state, and the states of the pixels on the scan line S(2) are to be set to the dark state, the data driver 110 provides the second voltage level V2 to the data lines during the corresponding time slots L1 and L3 of the scan line S(1), and provides the fourth voltage level V4 to the data lines during the corresponding time slots L2 and L4 of the scan line S(2). The fourth voltage level V4 can be a ground voltage level, 0V or other fixed reference voltages. Moreover, the fourth voltage level V4 is smaller than or equal to the first voltage level V1. Since the voltage amplitudes of the pixels on the scan line S(2) exceed the reflectivity transition voltage (the voltage VA shown in FIG. 3), the sates of the pixels are changed to the dark state.

Deduced by analogy, if the states of the pixels on the scan line S(1) are to be set to the dark state, and the states of the pixels on the scan line S(2) are to be set to the bright state, the data driver 110 provides the fourth voltage level V4 to the data lines during the corresponding time slots L1 and L3 of the scan line S(1), and provides the second voltage level V2 to the data lines during the corresponding time slots L2 and L4 of the scan line S(2). Since the voltage amplitudes of the pixels on the scan line S(1) exceed the reflectivity transition voltage (the voltage VA shown in FIG. 3), the sates of the pixels are changed to the dark state. If the states of the pixels on the scan lines S(1) and S(2) are all to be set to the dark state, the data driver 110 provides the fourth voltage level V4 to the data lines of the pixels during the time slots L1-L4.

Regarding the unselected (un-scanned) scan lines S(3)-S(N), regardless how the voltages of the data lines change, since the voltage of the scan lines S(3)-S(N) is maintained to the first voltage level V1, the voltage amplitudes of the pixels on the scan lines S(3)-S(N) do not exceed the reflectivity transition voltage (the voltage VA shown in FIG. 3), so that the sates of the pixels are not changed and are maintained to the bright state, as that shown in FIG. 5.

In summary, taking the pixel PX of FIG. 1 as an example, if the scan line S(1) is not selected (not scanned), i.e. the states of all of the pixels on the scan line S(1) are not changed, the first voltage level V1 is provided to the scan line S(1) of the pixel PX during the time slots of the line-scanning period L. Regarding the time slot L1, if the state of the pixel is to be set to the bright state, the data driver 110 and the scan driver 120 respectively provide the second voltage level V2 and the third voltage level V3 to the data line D(M) and the scan line S(1) of the pixel PX during the corresponding time slot L1. If the state of the pixel is to be set to the dark state, the data driver 110 and the scan driver 120 respectively provide the fourth voltage level V4 and the third voltage level V3 to the data line D(M) and the scan line S(1) of the pixel PX during the corresponding time slot L1.

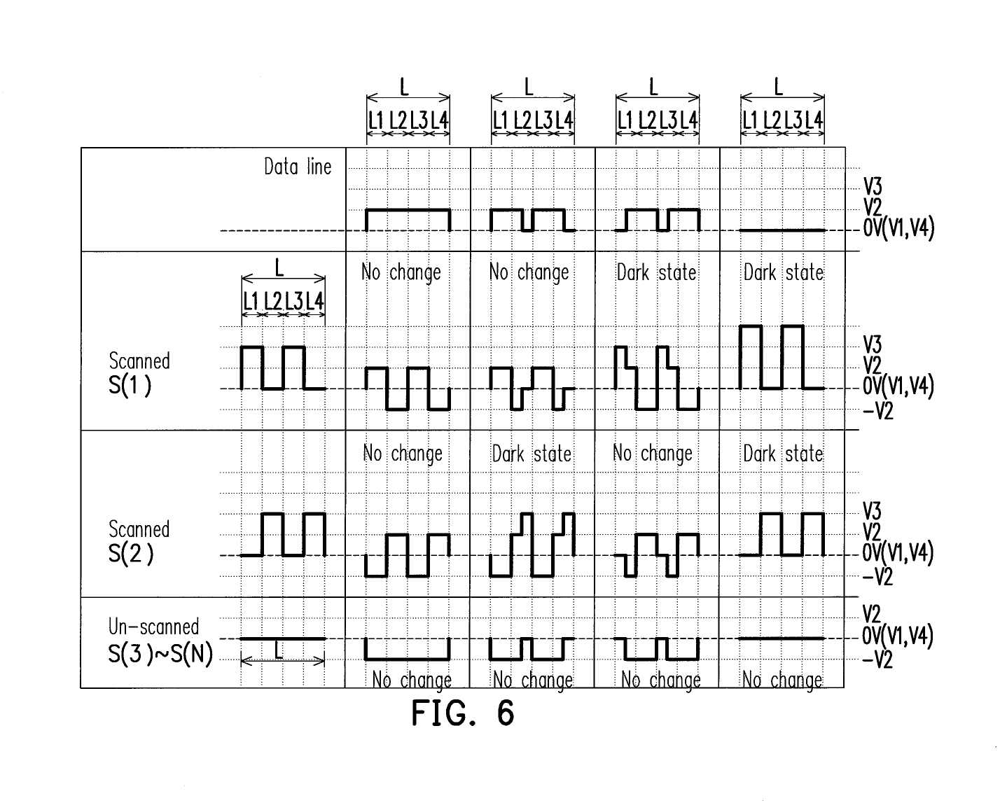

FIG. 6 is a diagram illustrating a driving method of the multi-stable display panel according to another exemplary embodiment of the disclosure. Similar to the exemplary embodiment of FIG. 5, it is also assumed that the scan driver 120 of FIG. 1 simultaneously drives two scan lines (i.e. n=2, referring to FIG. 4) during the same line-scanning period L, so that the scan driver 120 selects the scan lines S(1) and S(2) as the target scan lines during the first line-scanning period L of the frame driving period F. In FIG. 6, the driving waveforms during the first line-scanning period L of the frame driving period F of FIG. 4 are illustrated. The driving waveforms during the other line-scanning periods L can be deduced by analogy according to the embodiment of FIG. 5.

The exemplary embodiment of FIG. 6 can be deduced according to related descriptions of the exemplary embodiment of FIG. 5, so that a detail implementation thereof is not repeated. Different to the exemplary embodiment of FIG. 5, in the exemplary embodiment of FIG. 6, the first voltage level V1 is the same to the fourth voltage level V4, for example, the ground voltage level, 0V or other fixed reference voltages. Moreover, the data driver 110 can adjust a duty cycle of the data line according to a pulse width modulation (PWM) technique, so that dark state reflectivity of different pixels can be more balanced.

In the exemplary embodiments of FIG. 5 and FIG. 6, one line-scanning period L is divided into four time slots L1-L4. In other embodiment, one line-scanning period L can also be divided into n time slots L1-Ln. Here, Li represents an i^{th} time slot in the time slots L1-Ln, and S(i) represents an i^{th} scan line selected/driven from/in the n target scan lines. The scan driver 120 provides the third voltage level V3 to the target scan line S(i) during the corresponding time slot Li, and provides the first voltage level V1 to the other scan lines besides the target scan line S(i) during the other time slots besides the time slot Li.

Corresponding to the driving waveforms exerted to the target scan lines by the scan driver 120 during the line-scanning period L, the data driver 110 respectively provides the second voltage level V2 or the fourth voltage level V4 to the data lines D(1)-D(M) during the time slots L1-Ln. For example, if the state of a certain pixel on the scan line S(i) is to be set to the bright state, the data driver 110 provides the second voltage level V2 to the corresponding data line of the pixel during the time slot Li. Comparatively, if the state of a certain pixel on the scan line S(i) is to be set to the dark state, the data driver 110 provides the fourth voltage level V2 to the corresponding data line of the pixel during the time slot Li.

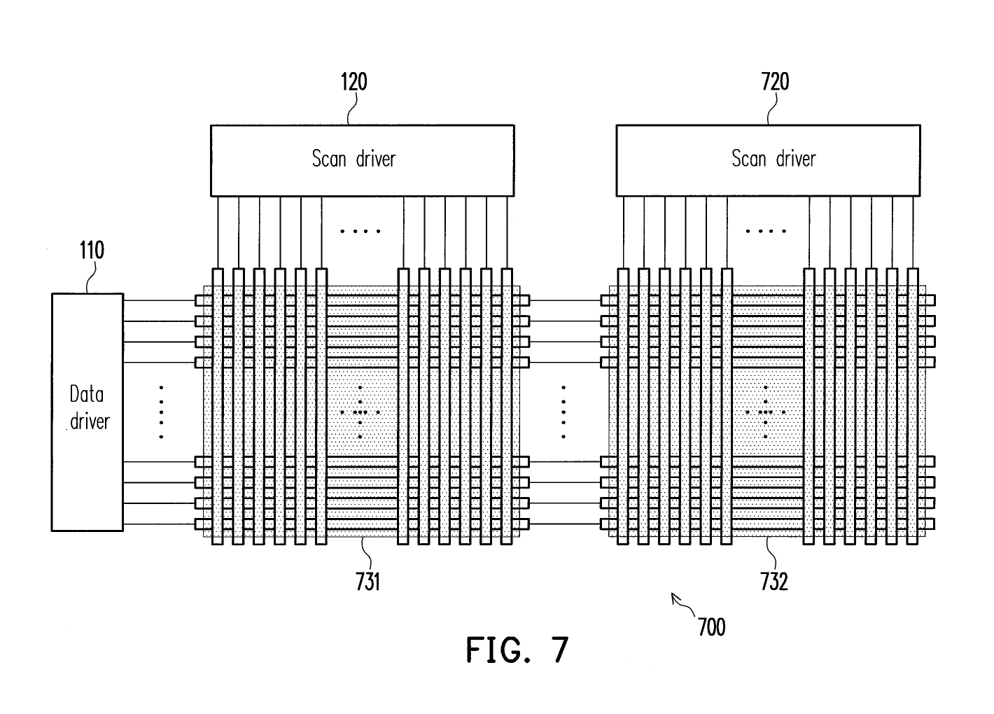

FIG. 7 is a functional block schematic diagram of a passive matrix (PM) multi-stable display 700 according to another exemplary embodiment of the disclosure. Related descriptions of the embodiments of FIGS. 4-6 can be referred for implementation details of the present exemplary embodiment. Different to the aforementioned embodiments, the multi-stable display 700 further includes a scan driver 720, a display panel 731 and a display panel 732. Related descriptions of the display panel 130 of FIG. 1 can be referred for implementations of the display panel 731 and the display panel 732. In the present exemplary embodiment, one data driver 110 simultaneously drives the two display panels 731 and 732 (or more display panels). One frame driving period F includes a plurality of the line-scanning periods L. The scan drivers 120 and 720 select/drive one or a plurality of the scan lines during one line-scanning period L. The scan lines selected/driven by the scan drivers 120 and 720 during the same line-scanning period L are referred to as the target scan lines.

The line-scanning period L includes a plurality of time slots. Each of the target scan lines corresponds to at least one time slot in the time slots, where the scan drivers 120 and 720 provide the first voltage level V1 or the third voltage level V3 (referring to related descriptions of FIG. 5 and FIG. 6) to the target scan lines during the time slots. Corresponding to the driving waveforms exerted to the target scan lines by the scan drivers 120 and 720 during the line-scanning period L, the data driver 110 respectively provides the second voltage level V2 or the fourth voltage level V4 to the data lines during the time slots (referring to related descriptions of FIG. 5 and FIG. 6). For example, the scan line S(1) of FIG. 5 and FIG. 6 can be the first scan line of the display panel 731, the scan line S(2) of FIG. 5 and FIG. 6 can be the first scan line of the display panel 732, the scan line S(3) of FIG. 5 and FIG. 6 can be the second scan line of the display panel 731, and the others are deduced by analogy. Therefore, the single set of data driver 110 can simultaneously drive the display panels 731 and 732 (or more display panels) to display different frames on the display panels 731 and 732.

In summary, according to the driving method and driving apparatus of the multi-stable display panel of the disclosure, n scan lines (n≧2) can be simultaneously driven during the same line-scanning period L. Compared to the conventional technique that only one scan line is driven during one line-scanning period L, the technique of the disclosure can effectively improve a data writing speed to achieve effects of fast driving and low power consumption, etc. In an application of multiple display panels, one set of data driver 110 is commonly used to simultaneously refresh frames of the multiple display panels, so as to achieve advantages of a low number of integrated circuits, a simplified system and low cost, etc. As a size of the ChLCD panel is increased, a time required for frame refreshing becomes longer, so that the technique disclosure by the disclosure is a necessity in application.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A method for driving a multi-stable display panel, comprising:
selecting a plurality of target scan lines from a plurality of scan lines of the multi-stable display panel;
providing a first voltage level to the other scan lines besides the target scan lines during a line-scanning period;
driving the target scan lines during the line-scanning period, wherein the line-scanning period comprises a plurality of time slots, the target scan lines are respectively provided with a third voltage level during at least a corresponding time slot of the time slots, and are provided with the first voltage level during other time slots besides the corresponding time slot; and
correspondingly providing a second voltage level or a fourth voltage level to a data line of the multi-stable display panel in the time slots.

2. The method for driving the multi-stable display panel as claimed in claim 1, wherein the fourth voltage level is a ground voltage level, 0V or a fixed reference voltage.

3. The method for driving the multi-stable display panel as claimed in claim 1, wherein the third voltage level is greater than the first voltage level, the second voltage level is between the first voltage level and the third voltage level, and the fourth voltage level is smaller than or equal to the first voltage level.

4. The method for driving the multi-stable display panel as claimed in claim 3, wherein the second voltage level is twice of the first voltage level, and the third voltage level is triple of the first voltage level.

5. The method for driving the multi-stable display panel as claimed in claim 1, further comprising:
providing a first reset voltage to the scan lines during a first stage and providing a second reset voltage to the scan lines during a second stage when a state of the multi-stable display panel is reset; and
providing the second reset voltage to the data line during the first stage and providing the first reset voltage to the data line during the second stage when the state of the multi-stable display panel is reset.

6. The method for driving the multi-stable display panel as claimed in claim 5, wherein the first reset voltage is greater than the third voltage level, and the second reset voltage is equal to or smaller than the fourth voltage level.

7. An apparatus for driving a multi-stable display panel, comprising:
a scan driver, for connecting a plurality of scan lines of the multi-stable display panel, and selecting a plurality of target scan lines from the scan lines, providing a first voltage level to the other scan lines besides the target scan lines during a line-scanning period, and driving the target scan lines during the line-scanning period, wherein the line-scanning period comprises a plurality of time slots, and the scan driver provides a third voltage level to each of the target scan lines during at least a corresponding time slot of the time slots, and provides the first voltage level to each of the target scan lines during the other time slots of the time slots; and
a data driver, for connecting at least one data line of the multi-stable display panel, wherein the data driver correspondingly provides a second voltage level or a fourth voltage level to the data line in the time slots.

8. The apparatus for driving the multi-stable display panel as claimed in claim 7, wherein the fourth voltage level is a ground voltage level, 0V or a fixed reference voltage.

9. The apparatus for driving the multi-stable display panel as claimed in claim 7, wherein the third voltage level is greater than the first voltage level, the second voltage level is between the first voltage level and the third voltage level, and the fourth voltage level is smaller than or equal to the first voltage level.

10. The apparatus for driving the multi-stable display panel as claimed in claim 9, wherein the second voltage level is twice of the first voltage level, and the third voltage level is triple of the first voltage level.

11. The apparatus for driving the multi-stable display panel as claimed in claim 7, wherein when a state of the multi-stable display panel is reset, the scan driver and the data driver respectively provide a first reset voltage and a second reset voltage to the scan lines and the data line during a first stage, and the scan driver and the data driver respectively provide the second reset voltage and the first reset voltage to the scan lines and the data line during a second stage.

12. The apparatus for driving the multi-stable display panel as claimed in claim 11, wherein the first reset voltage is greater than the third voltage level, and the second reset voltage is equal to or smaller than the fourth voltage level.

13. A method for driving a multi-stable display panel, comprising:
providing a first voltage level to a scan line of a pixel during a time slot of a line-scanning period when a state of the pixel is not changed;
respectively providing a second voltage level and a third voltage level to a data line and the scan line of the pixel during the time slot when the state of the pixel is to be set to a bright state, wherein the third voltage level is greater than the first voltage level, the second voltage level is between the first voltage level and the third voltage level; and
respectively providing the third voltage level and a fourth voltage level to the scan line and the data line during the time slot when the state of the pixel is to be set to a dark state, wherein the fourth voltage level is smaller than or equal to the first voltage level.

14. The method for driving the multi-stable display panel as claimed in claim 13, wherein the fourth voltage level is a ground voltage level, 0V or a fixed reference voltage.

15. The method for driving the multi-stable display panel as claimed in claim 13, wherein the second voltage level is twice of the first voltage level, and the third voltage level is triple of the first voltage level.

16. The method for driving the multi-stable display panel as claimed in claim 13, further comprising:
providing a first reset voltage to the scan lines during a first stage and providing a second reset voltage to the scan lines during a second stage when a state of the multi-stable display panel is reset; and
providing the second reset voltage to the data line during the first stage and providing the first reset voltage to the data line during the second stage when the state of the multi-stable display panel is reset.

17. The method for driving the multi-stable display panel as claimed in claim 16, wherein the first reset voltage is greater than the third voltage level, and the second reset voltage is equal to or smaller than the fourth voltage level.

18. An apparatus for driving a multi-stable display panel, comprising:
a scan driver, for connecting at least one scan line of the multi-stable display panel, wherein when a state of a pixel is not changed, the scan driver provides a first voltage level to the scan line of the pixel during a time slot of a line-scanning period, when the state of the pixel is to be set to a bright state or a dark state, the scan driver provides a third voltage level to the scan line of the pixel during the time slot, wherein the third voltage level is greater than the first voltage level; and
a data driver, for connecting at least one data line of the multi-stable display panel, wherein when the state of the pixel is to be set to the bright state, the data driver provides a second voltage level to the data line of the pixel during the time slot, and when the state of the pixel is to be set to the dark state, the data driver provides a fourth voltage level to the data line of the pixel during the time slot, wherein the second voltage level is between the first voltage level and the third voltage level, and the fourth voltage level is smaller than or equal to the first voltage level.

19. The apparatus for driving the multi-stable display panel as claimed in claim 18, wherein the fourth voltage level is a ground voltage level, 0V or a fixed reference voltage.

20. The apparatus for driving the multi-stable display panel as claimed in claim 18, wherein the second voltage level is twice of the first voltage level, and the third voltage level is triple of the first voltage level.

21. The apparatus for driving the multi-stable display panel as claimed in claim 18, wherein when a state of the multi-stable display panel is reset, the scan driver and the data driver respectively provide a first reset voltage and a second reset voltage to the scan lines and the data line during a first stage, and the scan driver and the data driver respectively provide the second reset voltage and the first reset voltage to the scan lines and the data line during a second stage.

22. The apparatus for driving the multi-stable display panel as claimed in claim 21, wherein the first reset voltage is greater than the third voltage level, and the second reset voltage is equal to or smaller than the fourth voltage level.
